(19) United States
(12) Patent Application Publication
(10) Pub. No.: US 2015/0301647 A1
(43) Pub. Date: Oct. 22, 2015

(54) TOUCH PANEL-TYPE INPUT DEVICE, METHOD FOR CONTROLLING THE SAME, AND STORAGE MEDIUM

(71) Applicant: SHARP KABUSHIKI KAISHA, Osaka (JP)

(72) Inventors: Yuichi SATO, Osaka-shi (JP); Kenji MAEDA, Osaka-shi (JP); Tatsuo WATANABE, Osaka-shi (JP); Kazuya TAKAYAMA, Osaka-shi (JP); Masayuki NATSUMI, Osaka-shi (JP); Tetsuya UMEKIDA, Osaka-shi (JP)

(73) Assignee: Sharp Kabushiki Kaisha, Osaka (JP)

(21) Appl. No.: 14/435,499

(22) PCT Filed: Oct. 15, 2013
(86) PCT No.: PCT/JP2013/077894

§ 371 Date: Apr. 14, 2015

(30) Foreign Application Priority Data
Oct. 17, 2012 (JP) 2012-229693

(51) Int. Cl. G06F 3/044; G06F 3/0484; G06F 3/0488; G06F 3/0481

(52) U.S. Cl. CPC G06F 3/044; G06F 3/04817; G06F 3/04842; G06F 3/04883; G06F 2203/04108; G06F 2203/04104; G06F 2203/04808

(57) ABSTRACT

An input device includes a touch panel including a touch sensor that detects an operation by an operator, and a display. The input device executes information processing based on information input on the touch sensor. The touch sensor is capable of changing a detection output to the information processing means, in accordance with a position of an object at a distance from the touch sensor. The input device also determines whether an operation on the touch sensor is performed with an operator's right hand or left hand, based on a distribution of the detection output from the touch sensor.

### TECHNICAL FIELD

The present invention relates to a touch panel-type input device, a method for controlling the same, and a program, and in particular, to a touch panel-type input device, a method for controlling the same, and a program that detects an operator's input characteristics.

### BACKGROUND ART

Various techniques have heretofore been proposed regarding touch panel-type input devices. A technique for determining characteristics of a user's operation, such as the user's dominant hand and the like, on such an input device, is particularly interesting from the viewpoint of improving convenience.

PTD 1 (Japanese Patent Laying-Open No. 2012-27581), for example, discloses a mobile terminal including sensors on a rear surface and side surfaces of an arrangement surface on which the keyboard is arranged. Each of these sensors outputs coordinate information in which a touch has been sensed. As a result, the mobile terminal detects a held state from the output coordinate information. The mobile terminal then estimates a movable range of the thumb based on the coordinate information, and causes the keyboard to be displayed based on the estimated movable range of the thumb.

PTD 2 (Japanese Patent Laying-Open No. 2008-242958) discloses an input device through which input is provided by pressing one or more buttons displayed on a touch panel. In the input device, a touch sensing region on the touch panel is defined for each button. The input device includes history recording means for recording past input information, first determination means for determining in which of the touch sensing regions for the buttons a user's touch position is included, second determination means for determining whether or not the touch position can be included in any of the touch sensing regions, based on the history recording information, where the first determination means has determined that the above-mentioned touch position is not included in any of the touch sensing regions, and position adding means for adding a touch position to the determined touch sensing region where the second determination means has determined that the touch position can be included. This allows recording and learning of the user's touch positions on the touch panel, so as to make an automatic correction of an error between the touch position and a normal button position.

PTD 3 (Japanese Patent Laying-Open No. 2011-164746) discloses a mobile terminal that accepts pen touch input. The mobile terminal includes an electromagnetic induction-type pen detecting unit and a capacitive detection-type finger detecting unit. The electromagnetic induction-type pen detecting unit obtains pen point coordinates (Xp, Yp) of the pen. The capacitive detection-type finger detecting unit obtains palm coordinates (Xh, Yh). When the pen point X coordinate Xp is smaller than the palm X coordinate Xh, the mobile terminal is set to a right-handed GUI (Graphical User Interface). On the other hand, when the pen point X coordinate Xp is larger than the palm X coordinate Xh, the mobile terminal is set to a left-handed GUI.

PTD 4 (Japanese Patent Laying-Open No. 2011-81646) discloses a display terminal that accepts input with a stylus pen. When the display terminal is touched with the stylus pen, a tilt direction is detected based on a detection output from a sensor incorporated in the stylus pen. The display terminal determines a user's dominant hand based on the detected tilt direction. The display terminal then controls the UI (User Interface) setting in accordance with the result of determination of the dominant hand. This allows the user to operate the display terminal via the UI corresponding to the user's dominant hand, without operating the display terminal more than once.

PTD 5 (Japanese Patent Laying-Open No. 08-212005) discloses a three-dimensional position recognition-type touch panel device. The touch panel device includes a plurality of sensors provided around a display surface in a vertical direction to detect a position of an object inserted into a space, calculation means for calculating the position over the display surface indicated by the object based on the result of the detection by the plurality of sensors, and display means for displaying an indication point shown to be indicated by the object on the position over the display surface obtained by the calculation means. The touch panel device confirms input where a sensor closest to the display surface has sensed the object inserted into the space, or where it is determined that the indication point has been present for a certain time within a predetermined area of coordinates representing an input area. Moreover, in the touch panel device, there is a correlation between a detected position of the tip of the object and a display magnification. This allows an input operation to be performed without directly touching the display surface with a finger or the like, or allows a plurality of enlarging operations to be done in a single input operation.

PTD 6 (Japanese Patent Laying-Open No. 2012-073658) discloses a computer system capable of multi-window operation. In the computer system, the window system executes control to assign a unique window to each of a plurality of application programs that operate in parallel. A motion sensor serving as a pointing device intermittently directs light to a user's hand that moves in a three-dimensional space, executes photographing processing while directing light and while not directing light, analyzes a differential image between an image obtained while directing light and an image obtained while not directing light, and detects the user's hand. The window system controls the window based on information on the user's hand detected by the motion sensor.

PTD 7 (Japanese Patent Laying-Open No. 2011-180712) discloses a projection image display apparatus. In the projection image display apparatus, a projection unit projects an image on a screen. A camera obtains an image of a region including at least the image projected on the screen. An infrared camera obtains an image of an upper space of the screen. A touch determining unit determines whether or not a user's finger is touching the screen, based on the image obtained by the infrared camera. When the touch determining unit determines that the finger is touching the screen, a coordinate determining unit outputs coordinates of the tip of the user's finger, based on the image obtained by the camera, as a pointing position on the projected image. This realizes the user's touch operation on the projected image.

PTD 8 (Japanese Patent Laying-Open No. 2001-312369) discloses an input device. The input device uses optical sensors to detect a position after an operation point is detected within a measurement space until it is touched on the detection panel, and a selected item is determined based on the detection output and a touch position on the screen. In this way, where, for example, there is an error between the device to detect a position immediately before it is touched on the screen and the device to detect a position touched on the screen, or where the operation position has moved to a neighboring item due to the operator operating the screen without viewing it directly from above, or where the operation point has moved slightly due to shaking of the operator's hand or for some other reason, even if an indication point is touched in a position somewhat different from the item that has previously been indicated in a different color, the operator's intended item can be selected to prevent erroneous input.

### CITATION LIST

### Patent Document

PTD 1: Japanese Patent Laying-Open No. 2012-27581
PTD 2: Japanese Patent Laying-Open No. 2008-242958
PTD 3: Japanese Patent Laying-Open No. 2011-164746
PTD 4: Japanese Patent Laying-Open No. 2011-81646
PTD 5: Japanese Patent Laying-Open No. 08-212005
PTD 6: Japanese Patent Laying-Open No. 2012-073658
PTD 7: Japanese Patent Laying-Open No. 2011-180712
PTD 8: Japanese Patent Laying-Open No. 2001-312369

### SUMMARY OF INVENTION

### Technical Problem

In an input device, it is considered to be important to detect input characteristics such as a user's dominant hand and the like, and control processing of input information based on such characteristics, since this can contribute to reducing erroneous input, for example. It is of particular importance which of the right and left hands the user uses to input information on the touch panel, as will be described below. The user inputs information on the touch panel either directly with a finger of his/her dominant hand, or by holding a stylus pen with his/her dominant hand. At this time, depending on which of the right and left hands is used to input the information, a shift from an actual position to be touched may occur, even though the user tries to touch the same point. Further, the degree of the shift of the touch position may change depending on the degree of tilt of the finger or stylus pen during input.

However, when a user's input characteristics are attempted to be detected using the conventional techniques, new issues will arise, for example, additional sensor(s) will be required with the techniques described in PTD 1 and PTDs 4 to 8, which leads to an increase in manufacturing costs for the devices. With the technique described in PTD 2, it is necessary to use the past erroneous input information, which requires time to correctly determine the touch position. Accordingly, a problem has remained in that it takes time until the user's input characteristics are grasped after the user has started using the device. Moreover, with the technique described in PTD 3, a certain range of input region is required to determine the user's dominant hand based on the input position of a pen or a finger. As communication devices become smaller in size, it is expected that there will be an increasing number of devices to which the technique described in PTD 3 is difficult to apply.

The present invention was made in view of the foregoing circumstances, and an object of the invention is to allow detection of a user's input characteristics even in a small touch panel-type input device, at an early stage after the user has started using the input device, without incorporating a special sensor into the input device.

### Solution To Problem

In accordance with one aspect, there is provided an input device including a touch panel with a touch sensor that detects an operation using an operation element. The input device further includes information processing means for executing information processing based on information input on the touch sensor. The touch sensor is capable of changing a detection output to the information processing means, in accordance with a position of an object at a distance from the touch sensor. The information processing means determines whether an operation on the touch sensor is performed with an operator's right hand or left hand, based on a distribution of the detection output from the touch sensor. The information processing means also obtains information for specifying a degree of tilt of the operation element with respect to the touch sensor, based on the distribution of the detection output from the touch sensor.

Preferably, where a touch operation on the touch sensor has been performed, a sensitivity of the touch sensor to detect the operation is increased, and where the determination by the information processing means has been completed, the sensitivity of the touch sensor is returned to the sensitivity before being increased.

More preferably, the sensitivity of the touch sensor to detect the operation is increased only on a section including a portion where the touch operation has been detected.

Preferably, where a touch operation on the touch sensor has been performed, a frequency of detecting the operation by the touch sensor is increased, and where the determination by the information processing means has been completed, the frequency is returned to the frequency before being increased. Where a touch operation on the touch sensor has been performed, a frequency of obtaining the detection output from the touch sensor by the information processing means is increased, and where the determination by the information processing means has been completed, the frequency is returned to the frequency before being increased.

Preferably, the information processing means corrects positional information input on the touch sensor, based on a result of the determination and the degree of tilt.

In accordance with another aspect, there is provided a method for controlling an input device executed by a computer of the input device, the input device including a touch panel including a touch sensor that detects an operation using an operation element. The controlling method includes the step of executing information processing based on information input on the touch sensor. The touch sensor is capable of changing a detection output to the information processing means, in accordance with a position of an object at a distance from the touch sensor. The step of executing information processing includes determining whether an operation on the touch sensor is performed with an operator's right hand or left hand, based on a distribution of the detection output from the touch sensor, and obtaining information for specifying a degree of tilt of the operation element with respect to the touch sensor, based on the distribution of the detection output from the touch sensor.

In accordance with a still another aspect, there is provided a program for controlling an input device executed by a computer of the input device, the input device including a touch panel including a touch sensor that detects an operation using an operation element. The program causes the computer to execute the step of executing information processing based on information input on the touch sensor. The touch sensor is capable of changing a detection output to the information processing means, in accordance with a position of an object at a distance from the touch sensor. The step of executing information processing includes determining whether an operation on the touch sensor is performed with an operator's right hand or left hand, based on a distribution of the detection output from the touch sensor, and obtaining information for specifying a degree of tilt of the operation element with respect to the touch sensor, based on the distribution of the detection output from the touch sensor.

### Advantageous Effects of Invention

In accordance with one aspect, the input device determines whether an operator is operating the touch sensor with the right hand or left hand, based on a distribution of the detection output from the touch sensor. The input device also obtains information for specifying a degree of tilt of the operation element with respect to the touch sensor, based on the distribution of the detection output from the touch sensor.

This allows even a small touch panel-type input device to detect a user's input characteristics at an early stage after the user has started using the input device, without including a special sensor.

### BRIEF DESCRIPTION OF DRAWINGS

FIG. 1 is a diagram showing an appearance of an input terminal according to a first embodiment of a touch panel-type input device.

FIG. 2 is a diagram for schematically illustrating an example of the manner of operating the display of the input terminal.

FIG. 3 is a diagram for illustrating a problem due to a shift of a detected touch position from an actual position to be touched on the touch sensor in (A) and (B).

FIG. 4 is a schematic diagram showing an example of the manner of operating the display when an operator inputs information on the display with a stylus pen.

FIG. 5 is a diagram for illustrating the mechanism for detecting an operation position on the display by means of a touch sensor in the input terminal.

FIG. 6 is a diagram showing one exemplary arrangement of the touch sensor in the input terminal.

FIG. 7 is a diagram for illustrating an influence due to a portion of a conductor not touching the display in the distribution of capacitances of electrodes in (A) and (B).

FIG. 8 is a diagram for illustrating an influence due to a portion of a conductor not touching the display in the distribution of capacitances of electrodes in (A) and (B).

FIG. 9 is a schematic diagram showing a distribution of detection outputs of individual electrode pairs arranged two-dimensionally throughout the entire touch sensor.

FIG. 10 is a block diagram showing one example of a hardware configuration of the input terminal.

FIG. 11 is a flowchart of processing for detecting a touch operation executed by the input terminal.

FIG. 12 is a diagram showing change in the operation mode in terms of change in the sensitivity of the touch sensor in the input terminal

### DESCRIPTION OF EMBODIMENTS

Embodiments of a touch panel-type input device will be described below with reference to the drawings. In the following description, elements with the same functions and effects are labeled with the same reference numerals throughout the drawings, and the same description will not be repeated.

### [Appearance of Input Device]

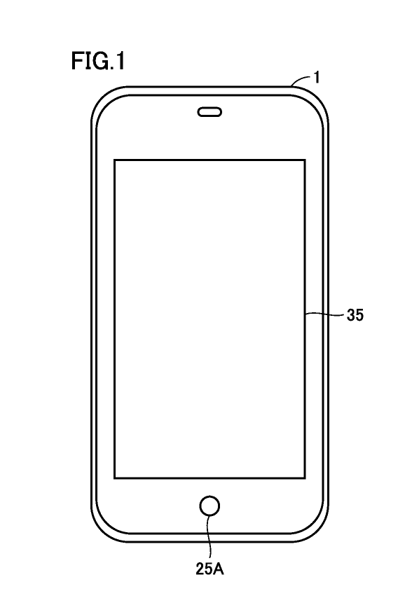

FIG. 1 is a diagram showing an appearance of an input terminal 1 according to a first embodiment of a touch panel-type input device. With reference to FIG. 1, input terminal 1 includes on its outer surface a display 35 and an input button 25A. Display 35 is a touch panel integral with a touch sensor 40 that will be described below. In this embodiment, input terminal 1 is implemented by a smart phone (high-performance mobile telephone). It is noted that input terminal 1 may be implemented by any other type of device that can have an information processing function described herein, such as a tablet terminal, a mobile telephone, or the like. In this embodiment, since touch sensor 40 is integral with display 35, a touch operation on touch sensor 40 may also be referred to as a “touch operation on the touch panel” or a “touch operation on display 35”, as appropriate. Touch sensor 40 and display 35 may be separate from each other instead of being integral.

### [Outline of Processing]

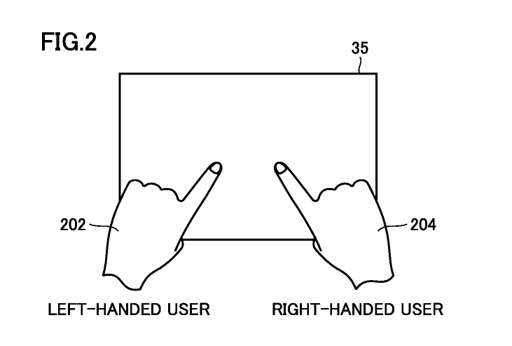

FIG. 2 is a diagram for schematically illustrating an example of the manner of operating display 35 of input terminal 1. With reference to FIG. 2, in input terminal 1, an operator can input information on display 35 either with the right hand or the left hand. In FIG. 2, a hand 202 shows positions of an operator's hand and finger on display 35 when he/she inputs information with the left hand. A hand 204 shows positions of an operator's hand and finger on display 35 when he/she inputs information with the right hand. If the operator is right-handed, he/she will usually input information on display 35 with the right hand. If the operator is left-handed, he/she will usually input information on display 35 with the left hand.

As is seen from FIG. 2, when information is input on display 35 with the operator's right hand (hand 204), the finger used for inputting extends to display 35 from the right-hand side of display 35. In this case, therefore, there may be a tendency for the finger to touch display 35 in a position somewhat shifted to the right from the operator's intended point. Moreover, in this case, if the detection output from the touch sensor of display 35 is affected by the position of the finger or the stylus pen at a distance from display 35, there may be a tendency for the touch position detected by the touch sensor to be shifted to the right from the touch position actually intended by the user. At this time, there may be a tendency for the detection output distribution of the touch sensor to be higher toward the right than the portion being touched. This is because not only the tip of the user's finger touches display 35, but also the other parts of the finger are closer to portions of display 35 toward the right than the touched position. Examples of touch sensors whose detection outputs are susceptible to the influence as described above include a capacitive detection sensor and an infrared detection sensor.

Further, as is seen from FIG. 2, when information is input on display 35 with the operator's left hand (hand 202), the finger used for inputting extends to display 35 from the left-hand side of display 35. In this case, therefore, there may be a tendency for the finger to touch display 35 in a position somewhat shifted to the left from the operator's intended point. Moreover, in this case, if the detection output from the touch sensor of display 35 is affected by the position of the finger or the stylus pen at a distance from display 35, there may be a tendency for the touch position detected by the touch sensor to be shifted to the left from the touch position actually intended by the user. At this time, there may be a tendency for the detection output distribution of the touch sensor to be higher toward the left than the portion being touched.

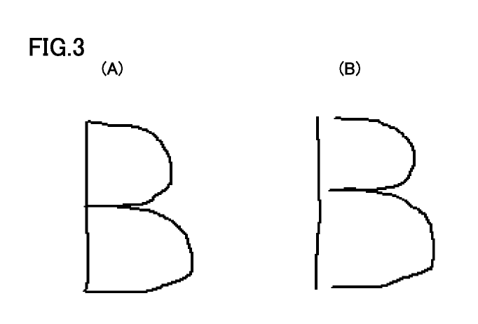

FIG. 3 is a diagram for illustrating a problem due to a shift of a detected touch position from an actual position to be touched on the touch sensor in (A) and (B). FIG. 3(A) illustrates one example of ideal handwritten input on display 35 upon detection and processing of the user's exact touch position in input terminal 1. On the other hand, FIG. 3(B) illustrates one example of handwritten input on display 35 when such a correction has not been made.

The degree of the shift as described above may also be affected by the direction in which the operator moves his/her finger while continuing touch input. For example, when a finger is moving from the right to the left, the amount of the shift tends to be small, and when a finger is moving from the left to the right, the amount of the shift tends to be large. In other words, when the direction in which the finger moves changes while drawing a single line such as a curve or the like, the amount of the shift described above may change. Thus, as shown in FIG. 3(B), even if the user touches display 35 along an orbit following the original letter, the orbit detected by display 35 may differ from the user's touched orbit. According to this embodiment, however, when the user touches display 35 along an orbit following the original letter, display 35 detects the orbit as it is, as shown in FIG. 3(A).

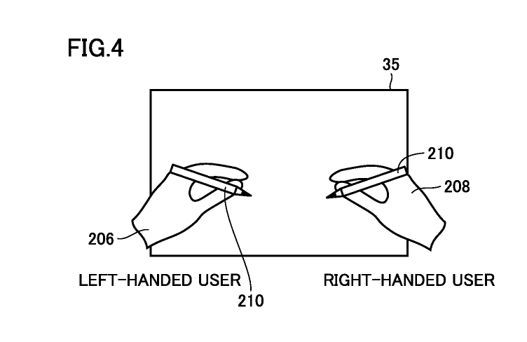

FIG. 4 is a schematic diagram showing an example of the manner of operating display 35 when an operator inputs information on display 35 with a stylus pen. With reference to FIG. 4, in input terminal 1, the operator can input information on display 35 using a stylus pen 210 held by right hand 208, or can input information on display 35 using stylus pen 210 held by left hand 206. If the operator is right-handed, he/she will usually input information on display 36 with stylus pen 210 held by the right hand. If the operator is left-handed, he/she will usually input information on display 35 with stylus pen 210 held by the left hand.

In this embodiment, it is determined whether the operator is inputting information on display 35 with the right hand or the left hand. Based on the determination result, input terminal 1 then corrects a detection output from the touch sensor of display 35 and/or adjusts a display content on display 35.

An example of a correction to the detection output may, for example, be made as follows. When it is determined that the operator is right-handed, the touch position specified by the detection output from the touch sensor is shifted to the left. The degree of the shift can be changed in accordance with the distribution of detection outputs from the touch sensor. For example, the amount of the shift can be increased as the tilt of the user's finger or hand (stylus pen 210) is determined to increase.

The display content on display 35 may be adjusted, for example, as follows. For example, the arrangement of icons displayed on display 35 may be adjusted. More specifically, when the operator is determined to be right-handed, the arrangement of icons is adjusted such that icons that are used with higher frequency are arranged toward the right. When the operator is determined to be left-handed, the arrangement of icons are adjusted such that icons that are used with higher frequency are arranged toward the left.

### [Illustration of Detection Mechanism]

Next, the mechanism in input terminal 1 for detecting whether the operator's operating hand is the right hand or the left hand will be described. Detecting that the operator's operating hand is the right hand may be expressed herein as detecting that the operator is right-handed. If the operator is right-handed, he/she will typically operate with the right hand. Detecting that the operator's operating hand is the left hand may be expressed herein as detecting that the operator is left-handed. If the operator is left-handed, he/she will typically operate with the left hand.

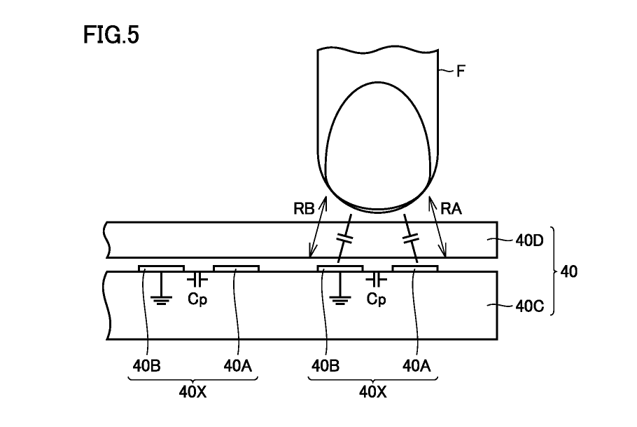

FIG. 5 is a diagram for illustrating the mechanism for detecting an operation position on display 35 by means of the touch sensor in input terminal 1.

FIG. 5 schematically shows a cross section of touch sensor 40. Touch sensor 40 includes a glass substrate 40C, electrode pairs 40X arranged on glass substrate 40C, and a protection plate 40D arranged on electrode pairs 40X. Electrode pairs 40X may be arranged on protection plate 40D instead of glass substrate 40C. Touch sensor 40 is arranged on a front surface of display 35 that displays the control state or the like of input terminal 1. The operator therefore visually recognizes what is displayed on display 35 through touch sensor 40. This embodiment illustrates a case where the touch panel is formed by display 35 and touch sensor 40.

It is noted that touch sensor 40 may be arranged on a rear surface of display 35. In this case, the operator visually recognizes what is displayed on display 35 through the front surface of input terminal 1, and performs a touch operation on the rear surface of input terminal 1.

Each electrode pair 40X includes an electrode 40A and an electrode 40B.

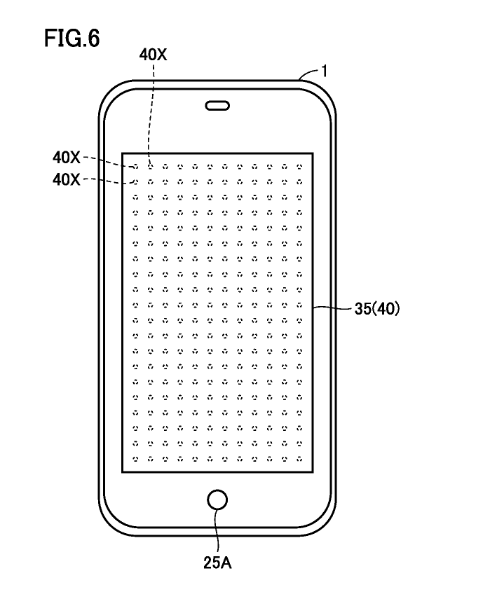

The capacitance of electrode 40A and the capacitance of electrode 40B of each electrode pair 40X change when a conductor approaches each of electrodes 40A and 40B. More specifically, as shown in FIG. 5, when (the operator's) finger F as an example of a conductor approaches electrode pair 40X, the capacitance of each of electrodes 40A and 40B changes in accordance with the distance from finger F. In FIG. 5, the distances between finger F and electrodes 40A and 40B are indicated by distances RA and RB, respectively. In input terminal 1, as shown in FIG. 6, electrode pairs 40X are arranged throughout touch sensor 40 (overlaid on display 35 in FIG. 6). Electrode pairs 40X are arranged in a matrix form, for example. In input terminal 1, the capacitances of electrodes 40A and 40B of each electrode pair 40X are detected independently from each other. In input terminal 1, therefore, a distribution of amounts of change in the capacitances of electrodes 40A and 40B of electrode pairs 40X can be obtained throughout touch sensor 40 (throughout display 35). Input terminal 1 then specifies the touch position on display 35 based on the distribution of amounts of change.

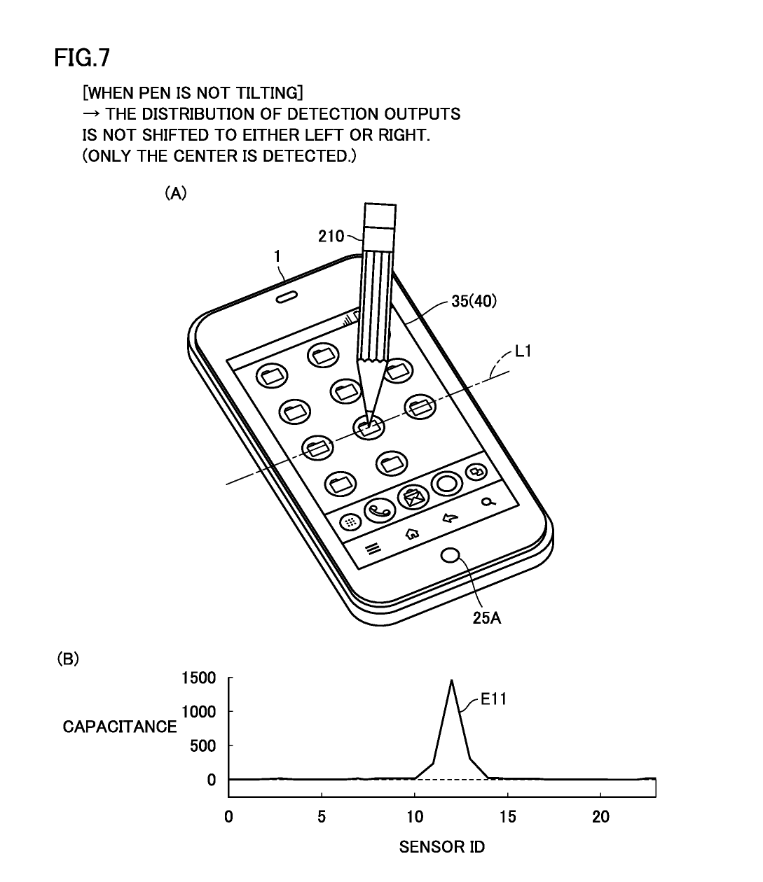

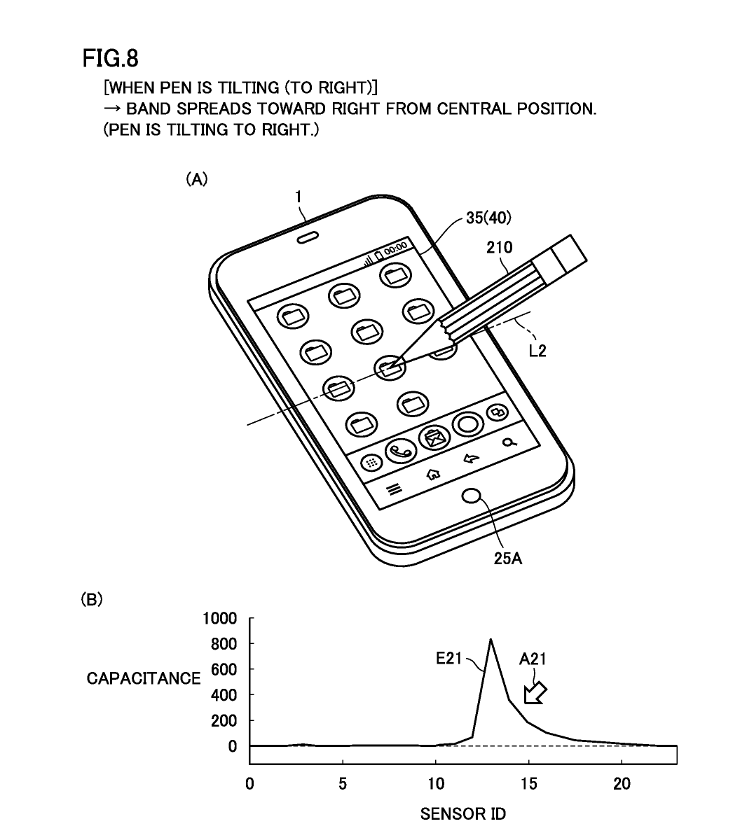

It is noted that even while the above-described conductor is not touching display 35 (touch panel), the capacitance of each of electrodes 40A and 40B can be affected by the position of the conductor (the distance between the conductor and each of electrode 40A and 40B). The distribution of capacitances of electrodes 40A and 40B, therefore, can be affected by whether the operator operates display 35 with the right hand or the left hand, as described with reference to FIG. 2. The distribution of capacitances of electrodes 40A and 40B can also be affected by whether the operator holds stylus pen 210 with the right hand or the left hand, as described with reference to FIG. 4. FIG. 7 and FIG. 8 are each diagrams for illustrating an influence due to a portion of the conductor not touching display (touch panel) 35 in the distribution of capacitances of electrodes 40A, 40B.

FIG. 7(A) illustrates a state in which stylus pen 210 is touching display 35 without tilting either to the right or to the left with respect to display 35. In FIG. 7(A), the horizontal direction is indicated by line L1.

FIG. 7(B) illustrates exemplary detection outputs of capacitances of electrode pairs 40X arranged on line L1 that correspond to FIG. 7(A). In the graph of FIG. 7(B), the vertical axis corresponds to capacitance. The horizontal axis corresponds to information specifying individual electrode pairs 40X arranged on line L1 (sensor ID). An output E11 shown in FIG. 7(B) corresponds to capacitances of electrodes 40B.

FIG. 8(A) illustrates a state in which stylus pen 210 is touching display 35 in input terminal 1 while tilting to the right with respect to display 35. In FIG. 8(A), the horizontal direction is indicated by line L2.

FIG. 8(B) illustrates exemplary detection outputs of capacitances of electrode pairs 40X arranged on line L2 that correspond to FIG. 8(A). In the graph of FIG. 8(B), the vertical axis corresponds to capacitance. The horizontal axis corresponds to information specifying individual electrode pairs 40X arranged on line L2 (sensor ID). An output E21 shown in FIG. 8(B) corresponds to capacitances of electrodes 40B.

In FIG. 8(B), output E21 has a gradient milder on the right-handed side of the peak position indicated by the hollow arrow head A21 than on the left-handed side. In input terminal 1, therefore, when the conductor (stylus pen 210) is present on display 35 with a tilt, the distribution of detection outputs of electrodes 40A and 40B of touch sensor 40 is also shifted to the same direction as the tilt.

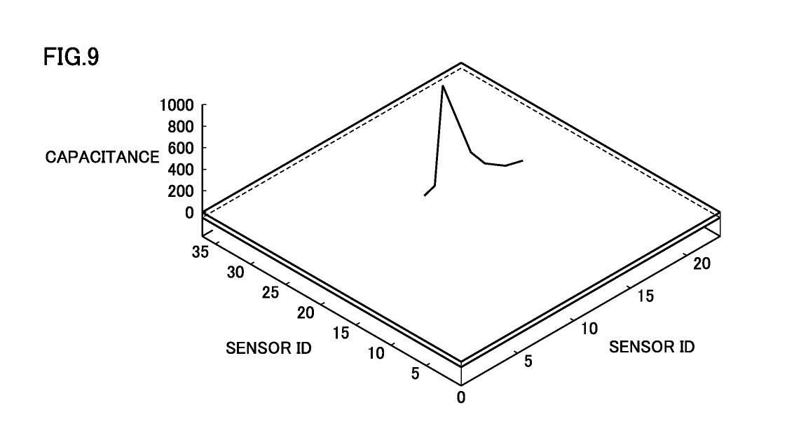

FIG. 9 is a schematic diagram showing a distribution of detection outputs of individual electrode pairs 40X arranged two-dimensionally (in a matrix form, for example) throughout touch sensor 40. It is noted that FIG. 9 shows detection outputs corresponding to the state shown in FIG. 8(A). In input terminal 1, as shown in FIG. 9, detection outputs of electrodes 40A and 40B of each electrode pair 40X arranged two-dimensionally throughout touch sensor 40 are obtained. Input terminal 1 specifies a vertical position where the peak of detection outputs is present. Then, as shown in FIG. 8(B), the degree of tilt of the conductor is predicted, based on the distribution of detection outputs in the horizontal direction in the specified position.

As described above, input terminal 1 predicts the tilt of the conductor based on the above-described distribution of detection outputs, by utilizing the relationship between the tilt of the conductor and the distribution of detection outputs of electrodes 40A, 40B. Input terminal 1 then determines, based on the prediction result of the tilt of the conductor, whether the operator is inputting information on display 35 with the right hand or the left hand.

Description will now be given of the tendency described with reference to FIG. 2 for the touch position detected by touch sensor 40 to be shifted to the right or left from the actual position to be touched, depending on the tilt of the conductor.

As described with reference to FIG. 5, the capacitance of each of electrodes 40A and 40B of touch sensor 40 may be affected by the distance from the conductor. Thus, even if the conductor is not touching touch sensor 40, the presence of the conductor near touch sensor 40 may affect the capacitance of each of electrodes 40A and 40B. When the operator inputs information on display 35 with the right hand, it is expected that the conductor (the operator's right hand) will be present near the right-handed side of the point where the operator's finger or stylus pen 120 is touching. Originally, in the graph as shown in FIG. 7(B) or FIG. 8(B), the capacitance peak coincides with the point where the operator's finger or stylus pen 120 is touching. However, it is expected that the presence of the conductor near the front surface of display 35 as described above may cause the position of the peak to shift toward the right from the original position intended to be touched by the user. For example, in the case of operation with a finger of the right hand, the user often tries to touch a place somewhat toward the left direction of the finger, rather than immediately below the finger. Since, however, the ball of the finger is on the center of the position touched on touch sensor 40, the peak position often shifts somewhat to the right direction. This is believed to be the same when the operator inputs information on display 35 with the left hand.

### [Hardware Configuration]

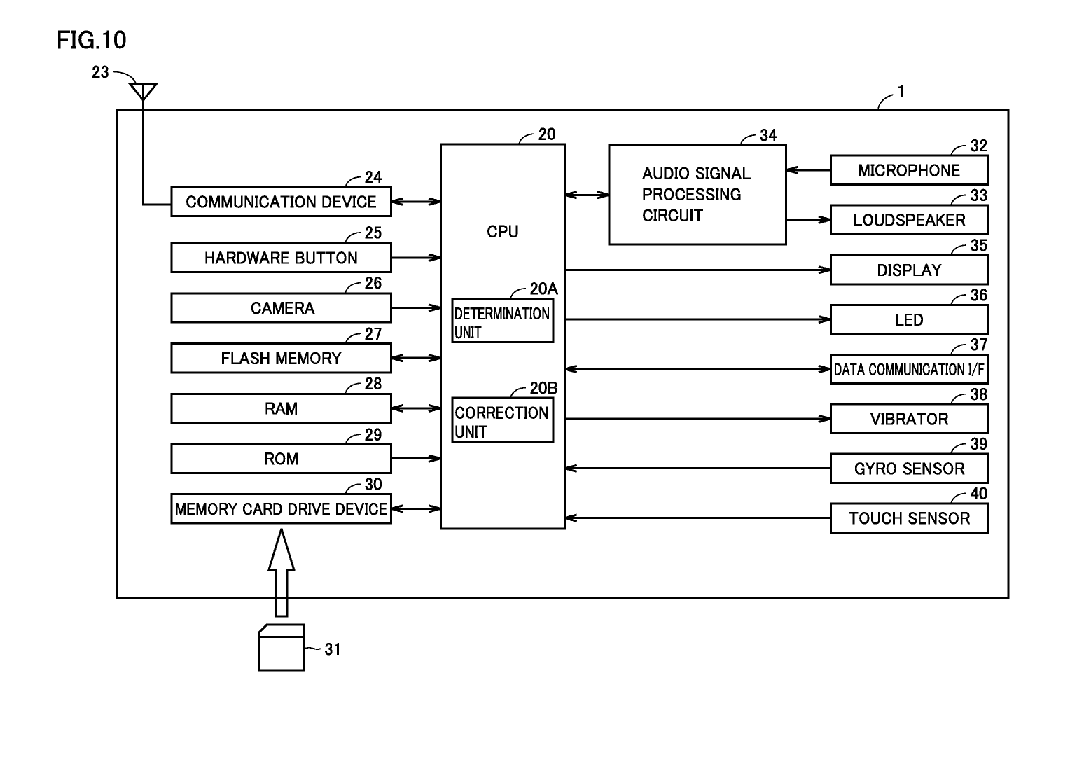

With reference to FIG. 10, a hardware configuration of input terminal 1 will be described. FIG. 10 is a block diagram showing an example of a hardware configuration of input terminal 1.

Input terminal 1 includes a CPU 20, an antenna 23, a communication device 24, hardware buttons 25, a camera 26, flash memory 27, a RAM (Random Access Memory) 28, a ROM 29, a memory card driving device 30, a microphone 32, a loudspeaker 33, an audio signal processing circuit 34, a display 35, an LED (Light Emitting Diode) 36, a data communication I/F 37, a vibrator 38, a gyro sensor 39, and a touch sensor 40. Memory card 3 may be inserted in memory card driving device 30.

Antenna 23 receives a signal sent from a base station, or transmits a signal for communicating with another communication device via the base station. The signal received by antenna 23 is subjected to front end processing by communication device 24, and then the processed signal is sent to CPU 20.

Touch sensor 40 accepts a touch operation on input terminal 1, and transmits to CPU 20 coordinate values of the point where the touch operation has been detected. CPU 20 executes predetermined processing in accordance with the coordinate values and the operation mode of input terminal 1.

It is noted that CPU 20 can determine whether the operator has used the right hand or the left hand for the touch operation, based on the detection output from touch sensor 40, as described above. CPU 20 can also correct the coordinate values of the point where the touch operation has been detected, based on the result of the determination. FIG. 10 shows these functions of CPU 20 as a determination unit 20A and a correction unit 20B.

Hardware buttons 25 include input button 25A. Each button included in hardware buttons 25 is externally operated to thereby cause a signal corresponding to each button to be input into CPU 20.

CPU 20 executes processing for controlling the operation of input terminal 1 based on a command issued to input terminal 1. When input terminal 1 receives a signal, CPU 20 executes predetermined processing based on the signal sent from communication device 24, and transmits the processed signal to audio signal processing circuit 34. Audio signal processing circuit 34 executes predetermined signal processing for that signal, and transmits the processed signal to loudspeaker 33. Loudspeaker 33 outputs a sound based on the signal.

Microphone 32 accepts an utterance to input terminal 1, and transmits a signal corresponding to the uttered sound to audio signal processing circuit 34. Audio signal processing circuit 34 executes predetermined processing for a telephone call based on the signal, and transmits the processed signal to CPU 20. CPU 20 converts the signal into data for transmission, and transmits the converted data to communication device 24. Communication device 24 generates a signal for transmission using the data, and transmits the signal towards antenna 23.

Flash memory 27 stores data sent from CPU 20. CPU 20 also reads data stored in flash memory 27, and executes predetermined processing using the data.

RAM 28 temporarily holds data generated by CPU 20 based on an operation performed on touch sensor 40 and other operations on the input terminal. ROM 29 stores a program or data for causing input terminal 1 to execute a predetermined operation. CPU 20 reads the program or the data from ROM 29, and controls the operation of input terminal 1.

Memory card driving device 30 reads data stored in memory card 31, and transmits the data to CPU 20. Memory card driving device 30 writes the data output from CPU 20 in free space on memory card 31. Memory card driving device 30 deletes the data stored in memory card 31, based on a command received from CPU 20.

It is noted that memory card driving device 30 may be replaced with a media drive that reads and writes information to a recording medium other than memory card 31. Examples of such recording media include media that store programs in a non-volatile manner, for example, a CD-ROM (Compact Disk-Read Only Memory), a DVD-ROM (Digital Versatile Disk-Read Only Memory), a Blue-ray disk, a USB (Universal Serial Bus) memory, a memory card, an FD (Flexible Disk), a hard disk, a magnetic tape, a cassette tape, an MO (Magnetic Optical Disk), an MD (Mini Disk), an IC (Integrated Circuit) card (except for a memory card), an optical card, a mask ROM, an EPROM, an EEPROM (Electronically Erasable Programmable Read Only Memory), and the like.

Audio signal processing circuit 34 executes the signal processing for a telephone call as described above. It is noted that while CPU 20 and audio signal processing circuit 34 are shown to be separate from each other in the example shown in FIG. 10, CPU 20 and audio signal processing circuit 34 in another aspect may be integral with each other.

Display 35 displays, based on the data obtained from CPU 20, an image defined by the data. Display 35 displays a still image, a motion image, and attributes of a music file (the name, the player, the performance time, and the like of the music file) stored in flash memory 27, for example.

LED 36 realizes a predetermined emission operation, based on a signal from CPU 20.

Data communication I/F37 accepts attachment of a cable for data communication. Data communication I/F37 transmits a signal output from CPU 20 to the cable. Alternatively, data communication I/F37 transmits the data received via the cable to CPU 20.

Vibrator 38 executes a vibration operation at a predetermined frequency, based on the signal output from CPU 20.

Gyro sensor 39 detects a direction of input terminal 1, and transmits the detection result to CPU 20. CPU 20 detects an attitude of input terminal 1 based on the detection result. More specifically, the housing of input terminal 1 has a rectangular shape, as shown in FIG. 1, for example. CPU 20 then detects, based on the above-described detection result, an attitude of the housing of input terminal 1, for example, whether the longitudinal direction of the rectangle is positioned vertically or horizontally to the user who visually recognizes display 35. It is noted that a known technique can be employed to detect the attitude of the housing of input terminal 1 based on the detection result of gyro sensor 39, and thus, detailed description thereof will not be repeated herein. Gyro sensor 39 may be replaced with any component that obtains data for detecting the attitude of the housing of input terminal 1.

### [Detection Processing for Touch Operation]

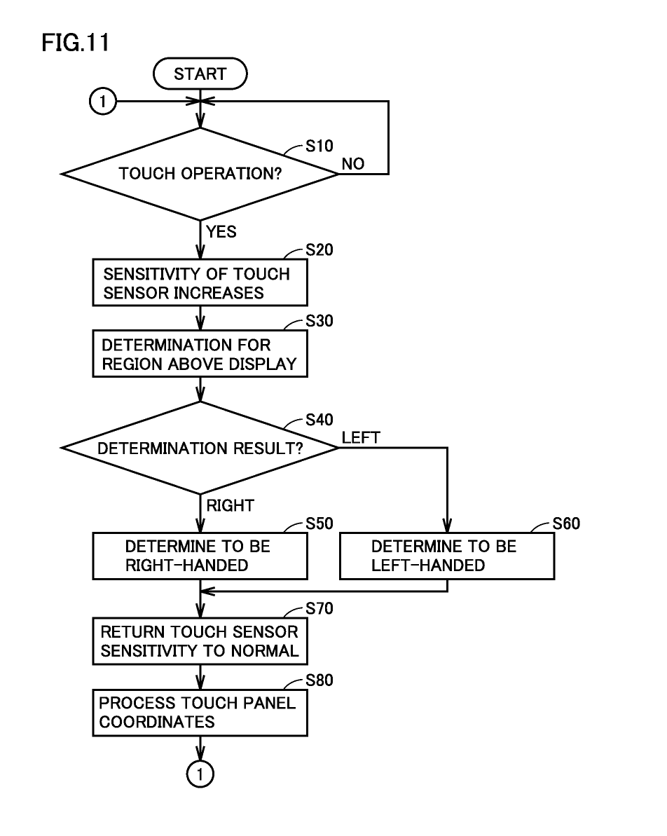

Next, with reference to FIG. 11, processing for detecting a touch operation on display 35 will be described. FIG. 11 is a flowchart of processing executed by CPU 20 for detecting a touch operation in input terminal 1. It is noted that the processing of FIG. 11 is continuously executed during a period in which input terminal 1 operates in a mode in which it accepts a touch operation on touch sensor 40.

With reference to FIG. 11, CPU 10 determines in step S10 whether or not a touch operation on touch sensor 40 has been performed. Where CPU 10 determines that no touch operation has been performed, CPU 10 waits until it detects a touch operation, and where CPU 10 determines that a touch operation has been performed, it proceeds to step S20. It is noted that as described with reference to FIG. 7(B), for example, CPU 10 determines that a touch operation has been performed where the absolute value of the capacitance of at least one of all electrode pairs 40X has reached a specific value or greater.

In step S20, CPU 20 changes the operation mode to increase the sensitivity of touch sensor 40, and proceeds to step S30. As referred to herein, “to increase the sensitivity of touch sensor 40” is realized by, for example, increasing the number of times of integration of sensing, or by enhancing the amount of information. The number of times of integration of sensing can be increased, for example, as follows. If CPU 20 previously used an integral of 8 outputs from each of electrodes 40A and 40B to determine a single detection output from each of electrodes 40A and 40B of each electrode pair 40X of touch sensor 40, CPU 20 may then use an integral of 32 outputs, which is 4 times greater. The amount of information can be enhanced, for example, by increasing the gain of a detection output from each of electrodes 40A and 40B in CPU 20.

In step S30, CPU 20 determines a state above display 35 (in a position at a slight distance from the surface of display 35), and proceeds to step S40. CPU 20 makes the determination by determining whether the conductor above display 35 tilts to the right as shown in FIG. 8(A) or tilts to the left. More specifically, as described with reference to FIGS. 7 to 9, CPU 20 creates a distribution of detection outputs of electrodes 40A and 40B of touch sensor 40, and based on the peak of detection outputs as the center, determines whether the distribution of detection outputs is shifted to the right (see FIG. 8(B)) or shifted to the left, so as to determine whether the conductor above display 35 tilts to the right or the left. It is noted that a vertical or horizontal direction may be determined using the detection result of the attitude of the housing of input terminal 1, based on the detection output of gyro sensor 39.

In step S40, CPU 20 determines, based on the determination result in step S30, whether it proceeds to step S50 or step S60. More specifically, where CPU 20 has determined in step S30 that the conductor above display 35 tilts to the right, CPU 20 proceeds to step S50. On the other hand, where CPU 20 has determined in step S30 that the conductor above display 35 tilts to the left, CPU 20 proceeds to step S60.

In step S50, CPU 20 determines that the operator is right-handed, and proceeds to step S70.

In step S60, CPU 20 determines that the operator is left-handed, and proceeds to step S70.

In step S70, CPU 20 returns the sensitivity of touch sensor 40 increased in step S20 to normal, and proceeds to step S80.

In step S80, CPU 20 executes processing for deriving coordinate values of an operation target on the touch panel (touch panel coordinate processing), and returns to step S10.

In step S80, CPU 20 can correct the coordinate values of the operation target on touch sensor 40 specified based on the touch operation detected in step S10 (the coordinate values of the operation target based on the detection outputs of electrodes 40A and 40B of touch sensor 40), based on the distribution of the detection result obtained in step S30. A known technique can be used to specify the coordinate values of the operation target based on the detection outputs of electrodes 40A and 40B of touch sensor 40, and thus, detailed description thereof will not be repeated herein. A specific example of the correction may be as described above as “an example of a correction to the detection output”.

CPU 20 delivers the coordinate values derived in step S80 to an application running on input terminal 1. At this time, CPU 20 may deliver the determination result in step S50 or step S60 along with the coordinate values to the application. The application can thus change, in accordance with the determination result, the content to be processed by the application including the display content on display 35, by adjusting the arrangement of icons as described above, for example. It is noted that this application may also be executed by CPU 20.

In the embodiment as described above, where CPU 20 cannot determine in step S40 whether the conductor tilts either to the right or to the left above display 35, CPU 20 proceeds to a predetermined one of step S50 and step S60, for example, to step S50.

### [Manner of Change in Driving Mode]

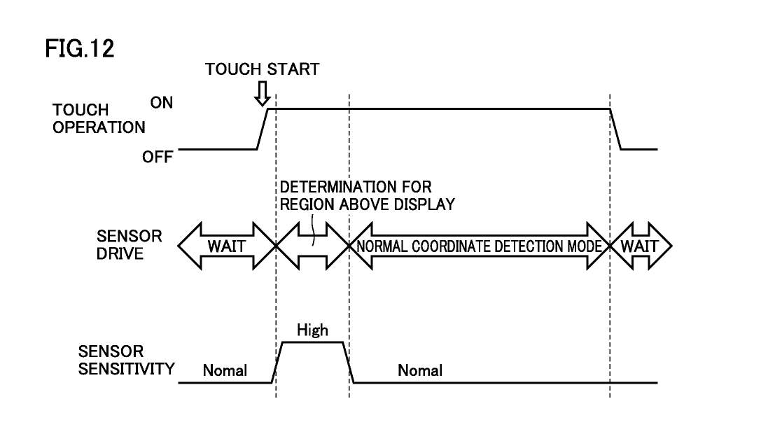

FIG. 12 is a diagram showing change in the operation mode in terms of change in the sensitivity of touch sensor 40 in input terminal 1 in this embodiment. FIG. 12 shows the presence or absence of a touch operation (touch operation), the driving mode of touch sensor 40 (sensor drive), and the sensitivity of touch sensor 40 in each driving mode (sensor sensitivity).

With reference to FIG. 12, the driving mode remains to be a waiting mode until a touch operation on touch sensor 40 is detected. Upon start of a touch operation (corresponding to proceeding from step S10 to step S20 in FIG. 11), the drive mode accordingly moves to a determination mode for a region above the display, in which the sensitivity of the sensor (touch sensor 40) increases. In FIG. 12, the sensitivity of the sensor before being increased is indicated as “Normal”, and the sensitivity of the sensor after being increased is indicated as “High”.

Then, the determination of the dominant hand is completed in step S50 or step S60 shown in FIG. 12, thus completing the determination mode for a region above the display. Accordingly, the increase in the sensitivity of the sensor is canceled. Thereafter, during the period in which the touch operation on touch sensor 40 is continued, detection of a normal touch position, for example, is continued (normal coordinate detection mode). Then, upon cancellation of the touch operation, the operation mode moves to the waiting mode again.

The determination mode for a region above the display and normal coordinate detection mode described above may be alternately executed during the period of a touch operation. In the determination mode for a region above the display, an output of the sensor may be susceptible to noise due to the increased sensor sensitivity. The positional accuracy of the touch operation may therefore become poor, and thus, touch position information obtained in the determination mode for a region above the display may not be used. If, however, the processing belonging to the determination mode for a region above the display (step S30 to step S60) is executed only once during the period of one touch operation, it may be possible that the determination of the touch position cannot follow change in the degree of tilt, for example. Therefore, where the determination of the touch position cannot follow such change, the determination mode for a region above the display and normal coordinate detection mode may be alternately executed during the period in which the touch operation is continued.

### [Effects and Modifications of Embodiment]

In the embodiment described above, upon detection of a touch operation of a conductor (stylus pen, finger, or the like) on touch sensor 40, it is determined whether the operator is right-handed or left-handed. In this way, the content to be processed by an application including the display content on display 35 can match the user's operating hand (right hand or left hand). It is noted that no other special sensor is required for the above-described determination, since the determination is made based on a detection output from touch sensor 40 incorporated for detecting a touch position on display 35. In this embodiment, the above-described conductor that inputs information on the touch sensor corresponds to an operation element.

Moreover, in this embodiment, the touch position (the touched coordinate values) on display 35 can be corrected based on the above-described result of determination. As described with reference to FIG. 3, this allows a reduction in the difference between the coordinate values of the touch operation obtained in input terminal 1 and the user's intended position.

In this embodiment, CPU 20 increases the sensitivity of touch sensor 40 during the period in which the operator's dominant hand (the hand used for operation) is being determined (step S20 to step S70). This allows CPU 20 to more correctly determine the dominant hand, and detect the degree of tilt.

The increase in the sensitivity of touch sensor 40 may lead to an increase in power consumption by input terminal 1. In this embodiment, however, the sensitivity is increased only during the above-described period, so that an increase in power consumption is minimized

Furthermore, the increase in sensitivity may increase the possibility that the output from touch sensor 40 to CPU 20 will contain noise, which may increase the error in the position specified based on the output from touch sensor 40. In order to avoid this, CPU 20 preferably executes the processing during the period from step S20 to step S70, based on the detection outputs from the electrode pairs located in the position where the touch operation is detected in step S10 and electrode pairs located near the detected position, of the plurality of electrode pairs 40X included in touch sensor 40. Furthermore, because the above-described error may increase during the period in which the sensitivity is increased, the positional information of the touch during this period may not be used, and only the dominant hand may be determined and tilt information may be obtained. This allows an influence of the error to be minimized

Moreover, increasing the number of times of integration of detection outputs from touch sensor 40 has been described as one exemplary manner of increasing the sensitivity. In this case, CPU 20 cannot specify a detection value of each of electrodes 40A and 40B of touch sensor 40 until it obtains a greater number of detection outputs from touch sensor 40 than normal. This may cause the processing to be slow. In this case, during the period from step S20 to step S70, the operating frequency of CPU 20 and touch sensor 40 may be increased. On the other hand, during the other periods, the operating frequency may be decreased to be lower than during the above-described period. In this way, an increase in power consumption can be minimized.

It should be understood that the embodiments and modifications disclosed herein are illustrative and non-restrictive in every respect. It is intended that the scope of the present invention is defined by the terms of the claims rather than by the foregoing description, and includes all modifications within the scope and meaning equivalent to the claims. The techniques disclosed in the embodiments and modifications thereof can be carried out alone or in combination, if possible.

### REFERENCE SIGNS LIST

1: input terminal; 20: CPU; 20A: determination unit; 20B: correction unit; 23: antenna; 24: communication device; 25: hardware button; 26: camera; 27: flash memory; 28: RAM; 29: ROM; 30: memory card driving device; 31: memory card; 32: microphone; 33: loudspeaker; 34: audio signal processing circuit; 35: display; 36: LED; 37: data communication I/F; 38: vibrator; 35: display; 39: gyro sensor; 40: touch sensor; 40A, 40B: electrode; 40C: glass substrate; 40D: protection plate; 40X: electrode pair.

1-7. (canceled)

8. A touch panel-type input device comprising a touch panel including a touch sensor that detects an operation using an operation element, said input device further comprising:
information processing unit that executes information processing based on information input on said touch sensor,
said touch sensor being capable of changing a detection output to said information processing unit, in accordance with a position of an object at a distance from said touch sensor,
said information processing unit determining whether an operation on said touch sensor is performed with an operator's right hand or left hand, based on a distribution of the detection output from said touch sensor, and
said information processing unit obtaining information for specifying a degree of tilt of said operation element with respect to said touch sensor, based on the distribution of the detection output from said touch sensor.

9. The touch panel-type input device according to claim 8, wherein
where a touch operation on said touch sensor has been performed, a sensitivity of said touch sensor to detect said operation is increased, and where the determination by said information processing unit has been completed, the sensitivity of said touch sensor is returned to the sensitivity before being increased.

10. The touch panel-type input device according to claim 9, wherein
the sensitivity of said touch sensor to detect said operation is increased only on a section including a portion where said touch operation has been detected.

11. The touch panel-type input device according to claim 8, wherein
where a touch operation on said touch sensor has been performed, a frequency of detecting said operation by said touch sensor is increased, and where the determination by said information processing unit has been completed, the frequency is returned to the frequency before being increased, and
where a touch operation on said touch sensor has been performed, a frequency of obtaining the detection output from said touch sensor by said information processing unit is increased, and where the determination by said information processing unit has been completed, the frequency is returned to the frequency before being increased.

12. The touch panel-type input device according to claim 8, wherein
said information processing unit corrects positional information input on said touch sensor, based on a result of the determination and the degree of tilt.

13. A method for controlling an input device executed by a computer of said input device, said input device comprising a touch panel including a touch sensor that detects an operation using an operation element, said method comprising the step of:
executing information processing based on information input on said touch sensor,
said touch sensor being capable of changing a detection output to said information processing unit, in accordance with a position of an object at a distance from said touch sensor,
the step of executing said information processing including:
determining whether an operation on said touch sensor is performed with an operator's right hand or left hand, based on a distribution of the detection output from said touch sensor; and
obtaining information for specifying a degree of tilt of said operation element with respect to said touch sensor, based on the distribution of the detection output from said touch sensor.

14. A non-transitory computer-readable storage medium storing a program executed by a computer of an input device, said input device comprising a touch panel including a touch sensor that detects an operation using an operation element,
said program causing said computer to execute the step of:
executing information processing based on information input on said touch sensor,
said touch sensor being capable of changing a detection output to said information processing unit, in accordance with a position of an object at a distance from said touch sensor,
the step of executing information processing including:
determining whether an operation on said touch sensor is performed with an operator's right hand or left hand, based on a distribution of the detection output from said touch sensor; and
obtaining information for specifying a degree of tilt of said operation element with respect to said touch sensor, based on the distribution of the detection output from said touch sensor.
